(19) United States
(12) Patent Application Publication
(10) Pub. No.: US 2018/0097272 A1
(43) Pub. Date: Apr. 5, 2018

(54) POWER COMBINER

(71) Applicant: TOKYO KEIKI INC., Tokyo (JP)

(72) Inventors: Motomu Matsunaga, Tokyo (JP); Hiroaki Saito, Tokyo (JP)

(21) Appl. No.: 15/833,056

(22) Filed: Dec. 6, 2017

Related U.S. Application Data
(63) Continuation of application No. PCT/JP2015/084714, filed on Dec. 10, 2015.

(30) Foreign Application Priority Data
Jun. 16, 2015 (JP) 2015-121571

(51) Int. Cl. H01P 5/22

(52) U.S. Cl. CPC H01P 5/227

(57) ABSTRACT

A power combiner includes a 90 degree hybrid circuit including first to fourth transmission lines, and first to fourth ports. The first transmission line, the second transmission line, the third transmission line and the fourth transmission line are connected to each other in this order to form a ring shape. The first port is connected at a connection portion between the first transmission line and the second transmission line; the second port is connected at a connection portion between the second transmission line and the third transmission line; the third port is connected at a connection portion between the third transmission line and the fourth transmission line; and the fourth port is connected at a connection portion between the fourth transmission line and the first transmission line. The 90 degree hybrid circuit has a thickness of 0.4 mm or greater.

### CROSS-REFERENCE TO RELATED APPLICATIONS

This application is based upon and claims the benefit of priority from the prior Japanese Patent Application No. 2015-121571, filed on Jun. 16, 2015 and PCT International Application No. PCT/JP2015/084714, filed on Dec. 10, 2015, the entire contents of which are incorporated herein by reference.

### FIELD

An embodiment of the present invention relates to a power combiner, and for example, to a power combiner using a 90 degree hybrid circuit usable in a microwave band.

### BACKGROUND

A high frequency power combiner is used for combining signals from a plurality of routes into one. Recently, a frequency band of a microwave band or longer is used in various fields, and high frequency power combiners usable for such a frequency band has been realized.

Conventionally, for handling a high frequency signal of a microwave band or the like, a power combiner uses, for example, a transmission line such as a microstrip line formed on a printed circuit board or a strip line formed in a dielectric component.

A microstrip line includes a conductor formed on each of two surfaces of a dielectric board. The conductor on a top surface of the dielectric board is a transmission line, and the conductor on a bottom surface of the dielectric board is a ground pattern, which is grounded. The dielectric constant and the thickness of the dielectric board, and the thickness and the width of the conductor, determine the characteristic impedance of the transmission line. The microstrip line, for example, has a structure suitable to be plane-mounted, may be patterned by etching and thus is easy to be processed, or may be subjected to approximation that ignores the thickness of the transmission line and thus is easy to be subjected to a numerical simulation. For these reasons, the microstrip line is in wide use.

### SUMMARY

A power combiner in an embodiment according to the present invention includes a first transmission line, a second transmission line, a third transmission line, a fourth transmission line, a first port, a second port, a third port and a fourth port. The first transmission line, the second transmission line, the third transmission line and the fourth transmission line are connected to each other in this order to form a ring shape. The first port is connected at a connection portion between the first transmission line and the second transmission line; the second port is connected at a connection portion between the second transmission line and the third transmission line; the third port is connected at a connection portion between the third transmission line and the fourth transmission line; and the fourth port is connected at a connection portion between the fourth transmission line and the first transmission line. Where the first port is an input port at a predetermined frequency, half of power of a signal input to the first port is output to each of the second port and the third port, no signal is output to the fourth port, and signals of the same amplitude as each other but of different phases from each other are input to the first port and the fourth port to output, to the second port or the third port, a sum of power of the signals input to the first port and the fourth port. The first transmission line, the second transmission line, the third transmission line and the fourth transmission line each have a thickness of 0.4 mm or greater.

### BRIEF DESCRIPTION OF DRAWINGS

FIG. 1 is a plan view showing a structure of a power combiner in an embodiment according to the present invention;

FIG. 2 is a cross-sectional view showing the structure of the power combiner in the embodiment according to the present invention;

FIG. 3 is a plan view showing a structure of a power combiner in an embodiment according to the present invention;

FIG. 4 is a plan view showing a structure of a 90 degree hybrid circuit included in a power combiner in an embodiment according to the present invention; and

FIG. 5 is a plan view showing a structure of a power combiner in an embodiment according to the present invention.

### DESCRIPTION OF EMBODIMENTS

Hereinafter, embodiments of the present invention will be described with reference to the drawings and the like. The present invention may be carried out in various forms without departing from the gist thereof, and is not to be construed as being limited to any of the following embodiments. In the drawings, components may be shown schematically regarding the width, thickness, shape and the like, instead of being shown in accordance with the actual sizes, for the sake of clearer illustration. The schematic drawings are merely examples and do not limit the interpretations of the present invention in any way. In the specification and the drawings, components that have substantially the same functions as those described before with reference to a previous drawing(s) bear the identical reference signs thereto, and detailed descriptions thereof may be omitted.

In the specification, an expression that a component is “on” another component encompasses a case where such a component is in contact with the another component and also a case where such a component is above or below the another component, namely, a case where still another component is provided between such a component and the another component, unless otherwise specified.

### Embodiment 1

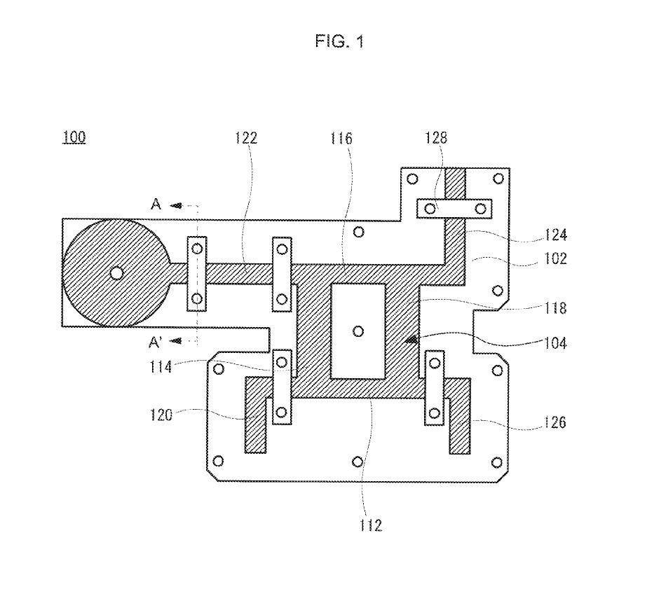

FIG. 1 is a plan view showing a structure of a power combiner 100 in this embodiment. The power combiner 100 in this embodiment includes a substrate 102 and a 90 degree hybrid circuit 104 provided on the substrate 102.

The 90 degree hybrid circuit 104 includes a first transmission line 112, a second transmission line 114, a third transmission line 116 and a fourth transmission line 118. The 90 degree hybrid circuit 104 further includes a first port 120, a second port 122, a third port 124 and a fourth port 126.

The first transmission lines 112 to the fourth transmission line 118 are connected in the order of the first transmission line 112, the second transmission line 114, the third transmission line 116 and the fourth transmission line 118 to form a ring shape. In this embodiment, the first transmission line 112 to the fourth transmission line 118 each have a rectangular shape with a limited width.

The first port 120 is connected to a connection portion between the first transmission line 112 and the second transmission line 114. Similarly, the second port 122 is connected to a connection portion between the second transmission line 114 and the third transmission line 116. The third port 124 is connected to a connection portion between the third transmission line 116 and the fourth transmission line 118. The fourth port 126 is connected to a connection portion between the fourth transmission line 118 and the first transmission line 112. The first port 120 to the fourth port 126 extend externally from the ring shape formed of the first transmission line 112 to the fourth transmission line 118 connected to each other.

For the power combiner 100 in this embodiment, the frequency of an input signal is assumed to be 2450 MHz. Based on this assumption, the first transmission line 112 and the third transmission line 116 are both designed to have a width of 4.9 mm and a length of 23.7 mm. The second transmission line 114 and the fourth transmission line 118 are both designed to have a width of 9.1 mm and a length of 30.6 mm. These values may be determined in accordance with the assumed frequency.

The 90 degree hybrid circuit 104 in this embodiment has the following structure. Where, for example, the first port 120 is an input port at a predetermined frequency, half of power of a signal input to the first port 120 is output to each of the second port 122 and the third port 124, and no signal is output to the fourth port 126. In addition, for example, signals having the same amplitude as each other are input to the first port 120 and the fourth port 126 at the same time. The signal to be input to the first port 120 has a phase of 0 degrees, and the phase of the signal to be input to the fourth port 126 is shifted by +90 degrees with respect to the phase of the signal to be input to the first port 120. As a result, the 90 degree hybrid circuit 140 outputs, to the second port 122, a signal of a total amplitude of the signals input to the first port 120 and the fourth port 126. In this case, no signal is output to the third port 124.

Alternatively, signals having the same amplitude as each other are input to the first port 120 and the fourth port 126 at the same time. The signal to be input to the first port 120 has a phase of 0 degrees, and the phase of the signal to be input to the fourth port 126 is shifted by −90 degrees with respect to the phase of the signal to be input to the first port 120. As a result, the 90 degree hybrid circuit 140 outputs, to the third port 124, a signal of a total amplitude of the signals input to the first port 120 and the fourth port 126. In this case, no signal is output to the second port 122.

When the power to be handled by a power combiner becomes large, there is a limit on use of a conventional microstrip line. Especially, it has been found that there is a problem that the microstrip line does not withstand the thermal stress caused by heat generation, which curves or melts the transmission lines. The 90 degree hybrid circuit 104 in this embodiment may be formed of a conventionally usable conductor such as copper or the like. The conductor preferably has a thickness of 0.4 mm or greater, and in this example, has a thickness of 0.4 mm. With such a structure, the 90 degree hybrid circuit 104 has an improved resistance against thermal stress caused by heat generation. Especially, the 90 degree hybrid circuit 104 withstands the heat generated when a 1 kW signal is input to each of the first port 120 and the fourth port 126 and a combined 2 kW signal is input to the second port 122 or the third port 124, and the transmission lines are prevented even from being curved or melted.

The substrate 102 is a dielectric substrate. The dielectric substrate may have a thickness of 2 mm or greater, and in this example, has a thickness of 3 mm. The dielectric substrate may be a resin substrate. The resin substrate may be, for example, a polytetrafluoroethylene (the commercial name is Teflon (registered trademark)) substrate, a glass-epoxy substrate or the like. Alternatively, a ceramic substrate may be used.

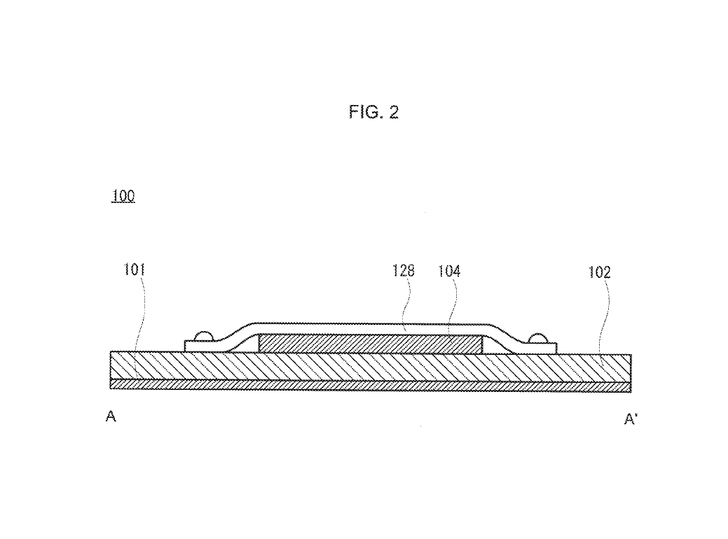

The power combiner 100 in this embodiment may further include a plurality of bands 128, which are used to secure the 90 degree hybrid circuit 104 onto the dielectric substrate 102 in order to improve the adherence between the substrate 102 (e.g., dielectric substrate) and the 90 degree hybrid circuit 104. FIG. 2 is a cross-sectional view taken along line A-A′ in FIG. 1. With such a structure, air is prevented from entering between the dielectric substrate and the 90 degree hybrid circuit 104, and thus the characteristic impedance of each of the transmission lines is suppressed from being shifted from the set value. Thus, the expected characteristics made by a numerical simulation performed before the power combiner 100 is produced are guaranteed to match the actual characteristics. Therefore, the characteristics are easily predicted.

In this embodiment, the 90 degree hybrid circuit 104 may be produced by a processing method such as etching or the like. Since the conductor is thicker than in the case where the conventional microstrip line is used, the 90 degree hybrid circuit may be produced by processing by use of a laser cutter or the like.

The thickness of the 90 degree hybrid circuit 104 included in the power combiner 100 in this embodiment is 0.4 mm or greater, which is larger than a conventional thickness, so that the resistance against thermal stress caused by heat generation is improved, which is advantageous to handle high power.

### Embodiment 2

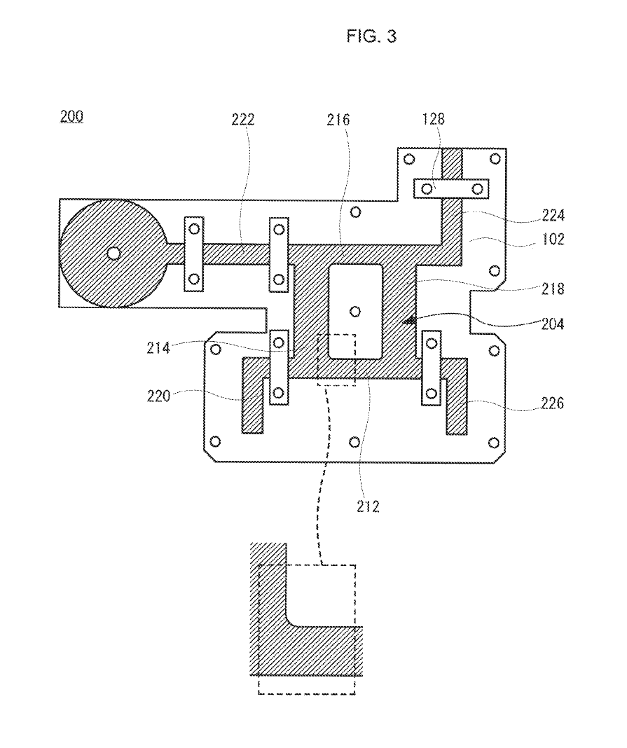

FIG. 3 is a plan view showing a power combiner 200 in this embodiment. A region enclosed by the dashed line includes a connection portion between a first transmission line 212 and a second transmission line 214 and the vicinity thereof, and this region is shown enlarged. Unlike in the power combiner 100 in embodiment 1, in the power combiner 200 in this embodiment, a connection portion between a first transmission line 212 and a second transmission line 214, a connection portion between the second transmission line 214 and a third transmission line 216, a connection portion between the third transmission line 216 and a fourth transmission line 218, and a connection portion between the fourth transmission line 218 and the first transmission line 212 each have an inner perimeter having a radius of curvature.

In other words, along an inner perimeter of the ring shape formed of the first transmission line 212 to the fourth transmission line 218 that are connected with each other, the connection portions between two adjacent transmission lines each have a radius of curvature.

The radius of curvature is preferably 1 mm or greater. In this example, all the connection portions have a radius of curvature of 1.3 mm

In the power combiner 100 in embodiment 1, the connection portions do not have a radius of curvature. An inner perimeter of the ring shape formed of the first transmission line 212 to the fourth transmission line 218 connected to each other forms a rectangular shape and is a combination of four line segment.

At, or in the vicinity of, the connection portions between two adjacent transmission lines, thermal stress caused by heat generation is likely to concentrate. In the case where the connection portions each have a radius of curvature as in the power combiner 200 in this embodiment, the concentration of the thermal stress caused by heat generation at, or in the vicinity of, the connection portions between the transmission lines is alleviated. This further improves the heat resistance of the entirety of the power combiner 200 including a 90 degree hybrid circuit 204, and the transmission lines are prevented from being curved or melted by thermal stress. Namely, the power combiner is suitable to handling of high power.

### Embodiment 3

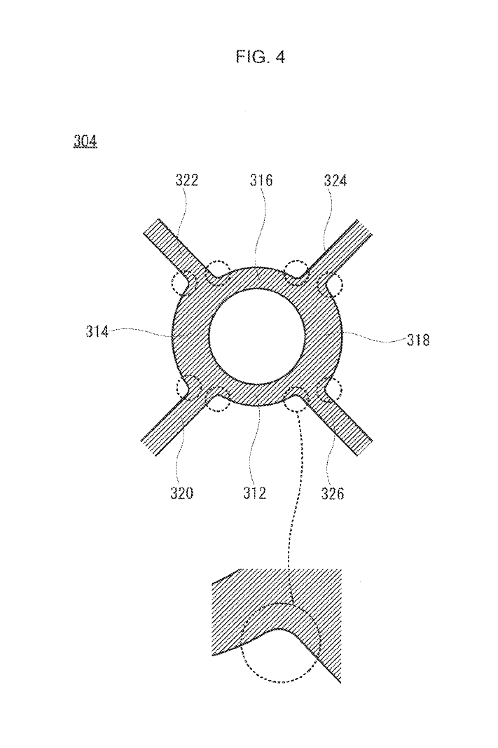

FIG. 4 is a plan view showing a 90 degree hybrid circuit 304 included in a power combiner in this embodiment. Unlike in the 90 degree hybrid circuit 204 in embodiment 2, in the 90 degree hybrid circuit 304 in this embodiment, an inner perimeter of a ring shape formed of a first transmission line 312 to a fourth transmission line 318 connected to each other forms a circular shape.

In other words, the first transmission line 312 to the fourth transmission line 318 each have an arc-shaped inner perimeter. In order to have a constant width, the first transmission line 312 to the fourth transmission line 318 also each have an arc-shaped outer perimeter.

For the power combiner in this embodiment, the frequency of an input signal is assumed to be 2450 MHz. Based on this assumption, the inner perimeter of the ring shape formed of the first transmission line 312 to the fourth transmission line 318 connected to each other is designed to have a radius of 13 mm. The arc-shaped first transmission line 312 and the arc-shaped third transmission line 316 each have a width of 5.7 mm. The arc-shaped second transmission line 314 and the arc-shaped fourth transmission line 318 each have a width of 9.9 mm.

In this example, a first port 320 to a fourth port 326 extend in a radial direction from a center of the circular inner perimeter. An angle made by the first port 320 and a second port 322, an angle made by the second port 322 and a third port 324, an angle made by the third port 324 and the fourth port 326, and an angle made by the fourth port 326 and the first port 320 are all about 90 degree. In this example, as a result of optimization made based on a numerical simulation, the angle made by the first port 320 and the second port 322, and the angle made by the third port 324 and the fourth port 326, are both designed to be 88°. The angle made by the second port 322 and the third port 324, and the angle made by the fourth port 326 and the first port 320, are both designed to be 92°. These values may be determined in accordance with the assumed frequency.

Unlike in the power combiner 200 in embodiment 2, in the power combiner in embodiment 3, as shown in the dashed circles in the figure, a connection portion between the first transmission line 312 and the first port 320, a connection portion between the first port 320 and the second transmission line 314, a connection portion between the second transmission line 314 and the second port 322, a connection portion between the second port 322 and the third transmission line 316, a connection portion between the third transmission line 316 and the third port 324, a connection portion between the third port 324 and a the fourth transmission line 318, a connection portion between the fourth transmission line 318 and the fourth port 326, and a connection portion between the fourth port 326 and first transmission line 312, each have a radius of curvature. The radius of curvature is preferably 1 mm or greater, and in this example, is 2 mm.

Such a structure further improves the heat resistance of the entirety of the power combiner including the 90 degree hybrid circuit 304, and the power combiner is suitable to handling of high power.

Unlike in the power combiner 200 in embodiment 2, in the power combiner in this embodiment, the 90 degree hybrid circuit 304 has a thickness of preferably 0.4 mm or greater, and in this example, has a thickness of 2 mm.

Such a structure further improves the heat resistance of the entirety of the power combiner including the 90 degree hybrid circuit 304, and the transmission lines are prevented from being curved or melted by thermal stress. Namely, the power combiner is suitable to handling of high power.

The shape of the transmission lines in the 90 degree hybrid circuit 304 in the power combiner in this embodiment is not limited to the shape described above with reference to the figure. For example, the inner perimeter of the ring shape formed of the first transmission line 312 to the fourth transmission line 318 connected to each other is not limited to forming a circular shape, and may be a closed curved line. The closed curved line may form, for example, an elliptical shape.

### Embodiment 4

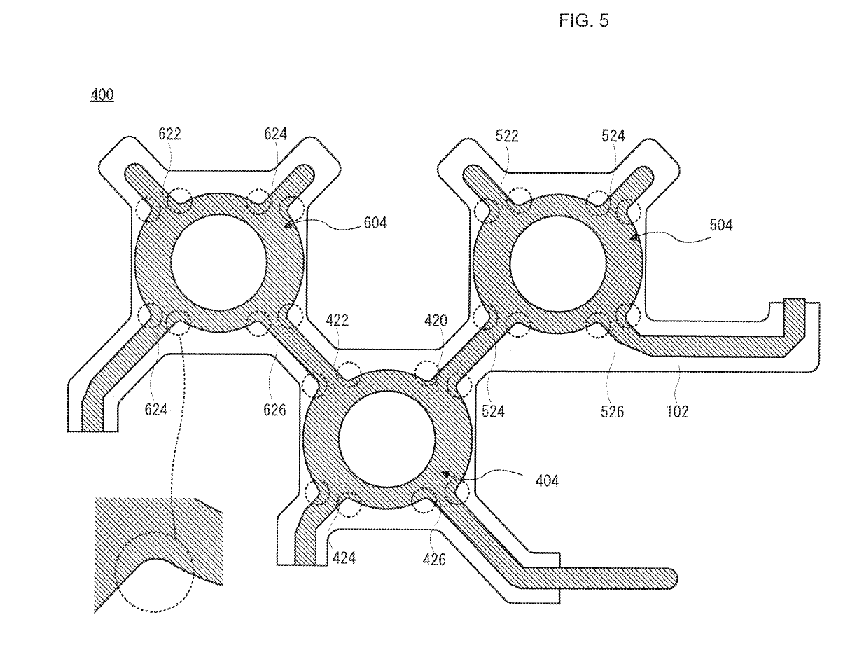

FIG. 5 is a plan view showing a power combiner 400 in this embodiment. The power combiner 400 in this embodiment includes a combination of three 90 degree hybrid circuits 304 each included in the power combiner. As shown in the dashed circles in the figure, like in FIG. 4, connection portions each have a radius of curvature.

Specifically, the power combiner 400 includes first to third 90 degree hybrid circuits (404a to 404c) each having the structure of the 90 degree hybrid circuit 304 in embodiment 3. A first port 420a of the first 90 degree hybrid circuit 404a and a third port 424b of the second hybrid circuit 404b are connected with each other. A fourth port 426a of the first 90 degree hybrid circuit 404a and a second port 422c of the third hybrid circuit 404c are connected with each other.

With such a structure, four signals input from a first port 420b and a fourth port 426b of the second 90 degree hybrid circuit 404b and a first port 420c and a fourth port 426c of the third 90 degree hybrid circuit 404c are output to a second port 422a of the first 90 degree hybrid circuit 404a.

The four input signals have the same amplitude as each other and the phases thereof are adjusted, so that a signal having an amplitude four times the amplitude of each of the input signals is output to the second port 422a of the first 90 degree hybrid circuit 404a. In addition, no signal is output to a third port 424a of the first 90 degree hybrid circuit 404a, a second port 422b of the second 90 degree hybrid circuit 404b, or a third port 424c of the third 90 degree hybrid circuit 404c.

With the above-described structure, a signal of higher power is produced by combination and output than in the case where a single 90 degree hybrid circuit is used. Especially in the case where input signals each having an amplitude of 1 kW are combined to output a signal of 4 kW, the transmission lines are prevented from being curved or melted by thermal stress.

Preferable embodiments according to the present invention have been described in embodiment 1 to embodiment 4. These embodiments are merely examples, and the technological scope of the present invention is not limited to any of these embodiments. A person of ordinary skill in the art would conceive various modifications or alterations without departing from the gist of the present invention. Such modifications and alterations are duly construed to be encompassed in the technological scope of the present invention.

What is claimed is:

1. A power combiner, comprising:
a first transmission line, a second transmission line, a third transmission line, a fourth transmission line, a first port, a second port, a third port and a fourth port;
the first transmission line, the second transmission line, the third transmission line and the fourth transmission line are connected to each other in this order to form a ring shape;
the first port is connected at a connection portion between the first transmission line and the second transmission line;
the second port is connected at a connection portion between the second transmission line and the third transmission line;
the third port is connected at a connection portion between the third transmission line and the fourth transmission line;
the fourth port is connected at a connection portion between the fourth transmission line and the first transmission line;
where the first port is an input port at a predetermined frequency, half of power of a signal input to the first port is output to each of the second port and the third port, no signal is output to the fourth port, and signals of the same amplitude as each other but of different phases from each other are input to the first port and the fourth port to output, to the second port or the third port, a sum of power of the signals input to the first port and the fourth port; and
the first transmission line, the second transmission line, the third transmission line and the fourth transmission line each have a thickness of 0.4 mm or greater.

2. The power combiner according to claim 1, wherein the first transmission line, the second transmission line, the third transmission line, the fourth transmission line, the first port, the second port, the third port and the fourth port form a 90 degree hybrid circuit.

3. The power combiner according to claim 1, wherein the first transmission line, the second transmission line, the third transmission line, and the fourth transmission line each have a thickness of 2 mm or greater.

4. The power combiner according to claim 1, wherein an inner perimeter of each of the connection portion between the first transmission line and the second transmission line, the connection portion between the second transmission line and the third transmission line, the connection portion between the third transmission line and the fourth transmission line, and the connection portion between the fourth transmission line and the first transmission line has a radius of curvature of 1 mm or greater.

5. The power combiner according to claim 4, wherein a perimeter of each of a connection portion between the first transmission line and the first port, a connection portion between the first port and the second transmission line, a connection portion between the second transmission line and the second port, a connection portion between the second port and the third transmission line, a connection portion between the third transmission line and the third port, a connection portion between the third port and the fourth transmission line, a connection portion between the fourth transmission line and the fourth port, and a connection portion between the fourth port and the first transmission line has a radius of curvature of 1 mm or greater.

6. The power combiner according to claim 5, wherein an inner perimeter of the ring shape formed of the first transmission line, the second transmission line, the third transmission line and the fourth transmission line connected to each other is a closed curved line.

7. The power combiner according to claim 6, wherein the inner perimeter of the ring shape formed of the first transmission line, the second transmission line, the third transmission line and the fourth transmission line connected to each other forms an elliptical shape.

8. The power combiner according to claim 7, wherein the inner perimeter of the ring shape formed of the first transmission line, the second transmission line, the third transmission line and the fourth transmission line connected to each other forms a circular shape.

9. The power combiner according to claim 1, further comprising a dielectric substrate;
wherein the first transmission line, the second transmission line, the third transmission line, the fourth transmission line, the first port, the second port, the third port and the fourth port are located on the dielectric substrate.

10. The power combiner according to claim 9, wherein the dielectric substrate is a resin substrate.

11. The power combiner according to claim 10, wherein the resin substrate is a polytetrafluoroethylene substrate.

12. The power combiner according to claim 9, wherein the dielectric substrate has a thickness of 2 mm or greater.

13. A power combiner, comprising:
a first 90 degree hybrid circuit;
a second 90 degree hybrid circuit; and
a third 90 degree circuit;
wherein the first 90 degree hybrid circuit, the second 90 degree hybrid circuit, and the third 90 degree circuit having a configuration of the 90 degree hybrid circuit according to claim 2,
wherein a first port of the first 90 degree hybrid circuit and a third port of the second 90 degree hybrid circuit are connected, and
wherein a forth port of the first 90 degree hybrid circuit and a second port of the forth 90 degree hybrid circuit are connected.
